(19) United States
(12) Patent Application Publication
(10) Pub. No.: US 2016/0292624 A1
(43) Pub. Date: Oct. 6, 2016

(54) Optimization of Inventory Through Prioritization and Categorization

(71) Applicant: DOW GLOBAL TECHNOLOGIES LLC, Midland, MI (US)

(72) Inventors: Cara J. Curtland, Vancouver, WA (US); Brad D. Wolf, Roseville, CA (US); Jerry Hwang, Cupertino, CA (US)

(21) Appl. No.: 15/032,979

(22) PCT Filed: Oct. 28, 2013
(86) PCT No.: PCT/US2013/060796

§ 371 Date: Jun. 29, 2016

(51) Int. Cl. G06Q 10/08; G06F 17/30

(52) U.S. Cl. CPC G06Q 10/087; G06F 17/3053

(57) ABSTRACT

A technique of prioritizing inventory levels for products that includes receiving, by at least one processor, a plurality of product metrics associated with each product of a plurality of products, categorizing, by the at least one processor, the plurality of products based on at least one metric of the plurality of metrics and a percentage value assigned to each of a plurality of categories, wherein the category determines an inventory level priority to assign to each of the plurality of products, and replacing, by the at least one processor, the category of a product based on an indicator.

### BACKGROUND

Supply chain management is tasked with overseeing inventory and stock of products and parts for the successful operation of a business. The management of the inventory, however, may be constrained by several variables and targets determined by the realities of being a business. Some of those variables may include budgetary targets, product priorities, and inventory costs. For supply chain management to fulfill their chartered tasks, the aforementioned constraints may limit their discretion on the maintenance of inventory. Thus, inventory maintenance may require optimization within those constraints.

### BRIEF DESCRIPTION OF THE DRAWINGS

For a detailed description of exemplary embodiments of the invention, reference will now be made to the accompanying drawings in which:

FIG. 1 shows a system diagram in accordance with various examples;

FIG. 2 shows an example of an inventory prioritization and categorization system in accordance with various examples;

FIG. 3 shows an illustrative implementation of an inventory prioritization and categorization system in accordance with various examples; and

FIG. 4 shows a method in accordance with various examples.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Supply chain management concepts may be used to efficiently manage product inventory levels to satisfy a number of factors. These factors may include stock level targets, budgetary constraints, profit margins, product volume, revenue, and cost of sales, to name a few. Some or all of these factors may be used to construct a supply chain philosophy that may ultimately drive the inventory target levels. This enacted philosophy, however, may make certain trade-offs between these factors when target inventory levels are determined. For example, a service level, defined as the percent of time that a customer's request for a product may be satisfied from stock, may be chosen depending on how willing a company may be in not satisfying a customer's request for a product. This may affect stock levels and cost of inventory since a high service level may increase the amount of stock required to be kept, which may directly affect the overall costs to the company. These tradeoffs may be implemented by the supply chain management infrastructure of the company.

Other trade-offs or weights may be assigned to various other variables associated with prioritizing stock levels, such as profit margin, volume, and revenue. Additionally, a product's category or strategy may also affect the stock levels, such as new product introduction, a product at the end of its life, targeted advertising campaigns, etc. All such factors may influence target stock levels of individual products and parts.

One technique to determine product inventory targets may be to first rank-order a list of products/parts based on a relative importance assigned to a plurality of factors, e.g., volume, profit, and revenue. The ranked list of products may then be categorized based on a second set of criteria. The second set of criteria may take one or more of the previous factors (other factors may also be implemented) and then a percentage assigned to each of a plurality of categories. For example, a category A may be assigned a percentage of 60% and the factor may be profit, which may lead to the top 60% of the list of products by profit are given the category of A. The categories may be associated with a target service level. A third set of criteria may apply overrides to a predefined subset of the products on the list such as designating all new products as category A and designating all end of life products as a category X. Then, based on the second and third sets of criteria, all of the products on the list are designated with a category level. Further, any attribute or ordinal value may be used to drive a specific override into a specific category without adhering to the ranking and categorization process. For example, a product designated for category B could be changed to category X based on an override indicator.

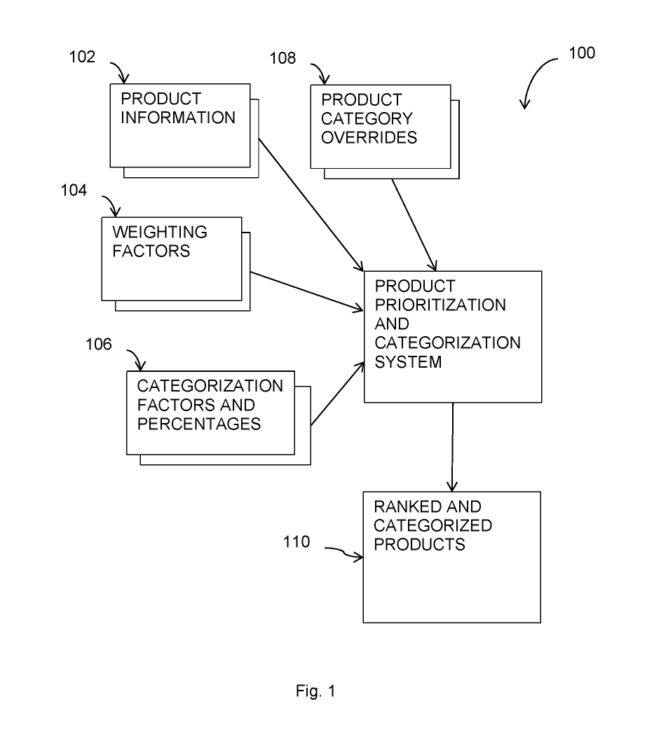

FIG. 1 shows an illustrative example of a product prioritization and categorization system 100 in accordance with various examples discussed herein. The inputs to the system 100 may comprise product information 102, weighting factors 104, categorization factors and percentages 106 and product category overrides 108. The output of the system 100 may at least include the ranking and category for each product included in the product information 102.

The product information 102 may include various attributes and data concerning a plurality of products. The various attributes and data in various combinations may be used by the system 100 in determining product priority and in designating a category to a product. The product information 102 may be contained in a single database or may be compiled from several databases distributed across an organization and connected via a network, such as a wide area network (WAN), a storage area network (SAN), or in various data servers connected to the internet. The various attributes of the plurality of products may include, per product, the volume of the product consumed/sold per a year/month, a monthly/yearly revenue amount, and a monthly/yearly profit amount. Additional attributes may be a business/campaign strategy each product may be associated, the strategy description, and a lifecycle indicator. The lifecycle indicator may show that a product is a new part introduction (NPI) or whether a product is at the end of its life cycle (EOL). The data associated with each product may include a point of re-order value, an assigned category from a previous fiscal quarter, a plan of record inventory priority, NPI/EOL dates, and current inventory level, to name a few.

The weighting factors 104 may include a number of metrics or factors that are relatively weighted. The factors/metrics may include profit, revenue, and volume, and inventory cost. Other factors may also be included and would fall within the scope of this disclosure, such as inventory value, market share, etc. Any number of or combination of the factors/metrics may be used to rank-order weights. For example, if volume, profit, and revenue are to be used for rank-ordering the plurality of products, then relative weights/priorities may be assigned to those factors, e.g., profit is given a 2 while revenue and volume are both given a 1. Hence, when rank-ordering the products, profit should be treated as twice as important as both revenue and volume. Any other means of weighting the factors relative to one another may also fall within the scope of this disclosure.

The categorization factor and percentages 106 may comprise a factor or factors and a percentage assigned therewith as to how the products are to be categorized. The factor may be one of the factors discussed above in conjunction with the weighting factors 104, or the factor used by the categorization factor and percentages 106 may be another attribute, e.g., inventory on hand. The percentages may be associated with a number of categories, such as A, B, C, D, E and X, which may indicate a service level target. The type and number of categories may vary and any such combination and number falls within the scope of this disclosure. The combination of the factor(s) and the percentages may be used to assign one of the categories to each of the products in the product list. For example, volume may be selected as the factor and the percentages of 60%, 30%, and 10% selected for categories A, B, and X, respectively.

The product category overrides 108 may replace the category designation assigned to a subset of the products based on attributes or data not accounted for when the system 100 categorizes the products based on the categorization factor and percentages 106 variables. The product category overrides 108 may replace a product's category designation with an A based on the product being a NPI. Additionally, the product category overrides 108 may replace a product's category designation with an X based on the product being phased out and it being within a threshold of weeks of its end date. The weeks left on a product's life may also be included in the product information 102. Further, a product's designated category may be replaced with an A if the product is associated with a specific strategy or campaign.

Alternatively, the product category overrides 108 may occur before the rank-ordered products are categorized by the system 100. By performing the overrides before categorization, the full list of overrides may be included in a high category level before the category is filled based on the associated percentage level. For example, If the top 60% of the ranked products are to be assigned to category level A based on profit, the system 100 may override the product ranking of a number of products based on a strategy designation by automatically placing them in category A regardless of their location in the rank-ordered list. By performing the override at this point, those products are guaranteed to be placed into category A.

The product prioritization and categorization system 100 processes the various inputs 102-108 and determines the priority level and category to assign to each product of the plurality of products in the production information 102. The assigned category, as noted, may determine an inventory service level of each product. The order of the process by the system 100 may be to first rank-order the products, categorize the products, and override/replace the designated category. Further, based on the weighting factors and how an individual part's factors change per fiscal quarter, the system 100 may assign different categories to a part for different fiscal quarters, or other relevant time periods, e.g., months, weeks, years, etc., going out as many fiscal quarters desired. Lastly, a user of the system 100 may manually adjust category designations to products after the final processing by the system 100.

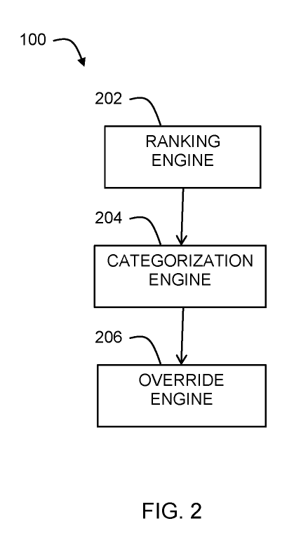

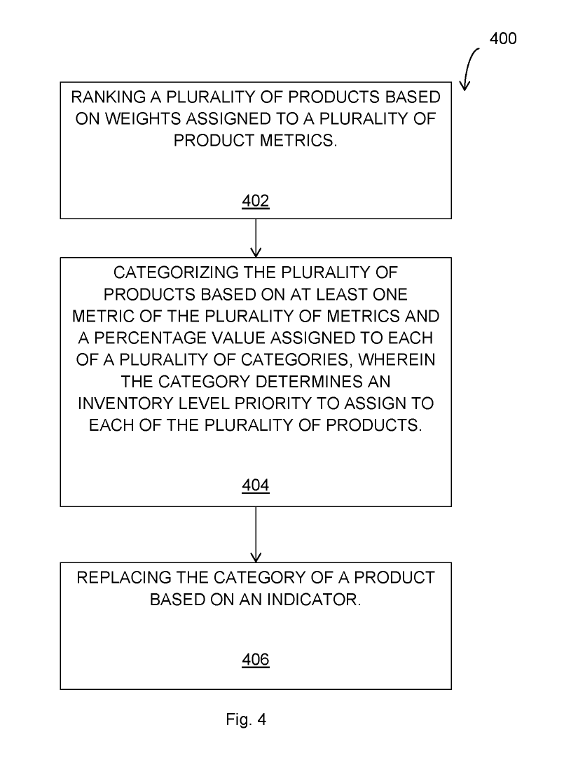

FIG. 2 illustrates an example of the product prioritization and categorization system 100. The illustrative system 100 of FIG. 2 includes various engines that provide the system with the functionality described herein. The system 100 may include a ranking engine 202, a categorization engine 204, and an override engine 206. Although the various engines 202-206 are shown as separate engines in FIG. 2, in other implementations, the functionality of all or a subset of the engines 202-206 may be implemented as a single engine. The functionality implemented on these engines will be further explained below with regard to FIG. 4.

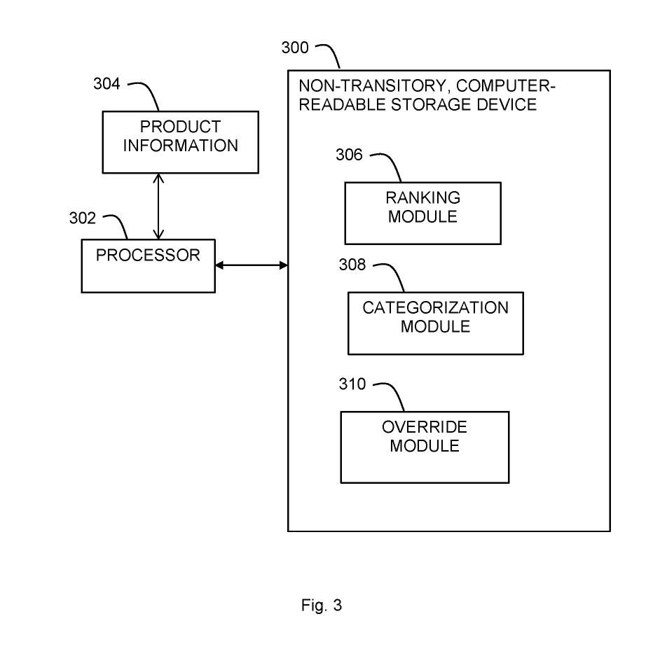

In some examples of the system 100, each engine 202-206 may be implemented as a processor executing software. FIG. 3, for example, shows one suitable example in which a processor 302 is coupled to a non-transitory, computer-readable storage device 300. The non-transitory, computer-readable storage device 300 may be implemented as volatile storage (e.g., random access memory), non-volatile storage (e.g., hard disk drive, optical storage, solid-state storage, etc.) or combinations of various types of volatile and/or non-volatile storage.

The non-transitory, computer-readable storage device 300 is shown in FIG. 3 to include a software module that corresponds functionally to each of the engines of FIG. 2. The software modules may include a ranking module 306, a categorization module 308, and a override/replacement module 310. Each engine of FIG. 2 may be implemented as the processor 302 executing the corresponding software module of FIG. 3.

The distinction among the various engines 202-206 and among the software modules 306-310 is made herein for ease of explanation. In some implementations, however, the functionality of two or more of the engines/modules may be combined together into a single engine/module. Further, the functionality described herein as being attributed to each engine 202-206 is applicable to the software module corresponding to each such engine, and the functionality described herein as being performed by a given module is applicable as well as to the corresponding engine.

FIG. 4 is an example flow chart of a method 400 for implementing the product prioritization and categorization system 100. The various operations depicted in FIG. 4 may be performed in the order shown or in a different order and two or more of the operations may be performed in parallel instead of serially. Additionally, the steps of the method 400 may be performed by one or more of the various engines 202-206 of FIG. 2 and/or the various software modules 306-310 of FIG. 3.

At 402 the method 400 begins with ranking a plurality of products based on weights assigned to a plurality of product metrics. The list of products and their associated metrics may be obtained from a product information database 304 as shown in FIG. 3 similar to the product information 102, and the weighting factors 104 of FIG. 1. The product information database 304 is shown separate from the non-transitory, computer-readable storage device 300, but may also be included therein. The ranking of the plurality of products may be performed by the ranking engine 202 or by the processor 302 executing the code of the ranking module 306.

Based on the weighting factors 104, the plurality of parts may be rank-ordered based on the respective weights assigned to the plurality of metrics. For example, if profit is given an importance level twice that of volume, which is given a higher priority over revenue, then the processor 302 executing the ranking engine 306 may rank-order the plurality of products first by profit, then by volume and then by revenue generating the rank-ordered list. Stated another way, the list of products are rank-ordered using a weighted average of the metrics based on their assigned weights.

At 404 the method 400 continues with categorizing the plurality of products based on at least one metric of the plurality of metrics and a percentage value assigned to each of the plurality of categories. The category, as noted above, may determine an inventory level priority or service level target to assign or designate for each product of the plurality of products. The metric and percentage on which the categorization is based may be supplied to either the categorization engine 204 or to the processor 302 executing the categorization module 308 by the categorization factor/percentages 106 of FIG. 1. The metric or metrics used to base the categorization may be one of the same metrics used for prioritizing the plurality of products. The percentages may be used to set thresholds or cut-offs for separating the various categories assigned to the products. For example, if a percentage of 70% is associated with category A and the factor chosen is profit, then the top products making up 70% of the profit may be assigned to category A.

Due to the list of products being rank-ordered, the list finite, and each part having an associated profit, a total profit amount may be calculated. Then, the categorization engine 204 may begin assigning the category A to the first product on the list and then move down the list assigning As until 70% of the total profit is reached. The remainder of the list may be assigned to various other categories based on other percentages in the same manner. For example, the remainder of the list may be assigned the category B.

At 406 the method 400 continues with replacing the category assigned to a product based on an indicator or a strategy (e.g., the product lifecycle indicator). The category may be replaced based on product category override indicators 108. The assigned categories may be replaced/changed by the override/replacement module 310 being executed by the processor 302. To illustrate by example, a product may be given a category of B by the categorization engine 204, but that product may be designated strategic. The override/replacement engine 206 may then change the assigned category of B to an A as directed by the product category override indicators 108. Other types of overrides may be to change a product's category assignment to A due to the product being new, i.e., NPI, or to change a product's category designation to X due to the product closing in on its end of life.

Additionally or alternatively, the overrides, the replacing of assigned categories, may be applied before assigning categories based on the percentage threshold assigned to those categories, thus preserving the percentage threshold as long as the overrides allow. For example, if percentage profit is set to 10% for category A and the NPI/Strategic parts that are to be assigned to A make up 15% of the profit total, there may be no room to add additional product to A and the categorization engine 204 may not be able to maintain the 10% threshold for category A. On the other hand, if the overrides make up 8% of the total profit, additional products may be added to A, but only up to the 10% threshold. Then, other products may be assigned to other categories according to the rank order and percentage threshold set for each category.

At the completion of the method 400, the plurality of products may be categorized with each category determining a target stock level or service level for that product. Further, the system 100 implementing the method 400 may assign category levels to each product for a number of time periods. The category assigned to each product may be different in each fiscal quarter due to changes in strategy, product lifecycle, demand, lead time, etc.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A method of prioritizing inventory levels for products, comprising:
ranking, by at least one processor, a plurality of products based on weights assigned to a plurality of product metrics;
categorizing, by the at least one processor, the plurality of products based on at least one metric of the plurality of metrics and a percentage value assigned to each of a plurality of categories, wherein the category determines an inventory level priority to assign to each of the plurality of products; and
replacing, by the at least one processor, the category of a product based on an indicator.

2. The method of claim 1, further comprising receiving, by the at least one processor, the plurality of product metrics associated with each product of the plurality of products.

3. The method of claim 1, wherein the plurality of metrics comprises volume, profit, and revenue.

4. The method of claim 1, wherein the indicator comprises a product lifecycle indicator that indicates that a product is a new product.

5. The method of claim 1, wherein the percentage value assigned to the plurality of categories determines a threshold of the at least one metric to assign to a first category.

6. A system, comprising:
a ranking engine to rank-order a plurality of products based on weights assigned to each metric of a plurality of metrics, wherein the plurality of products will be ranked by the metric of the plurality of metrics with a highest weight first;
an override engine to place at least one product of the plurality of products into a specific category based on a product lifecycle indicator associated with the at least one product; and
a categorization engine to categorize each of the ranked plurality of products, other than the at least one product that the override engine placed into a specific category, based on at least one metric of the plurality of metrics and a percentage of the at least one metric associated with a plurality of categories, wherein the category determines an inventory level priority to assign to each of the plurality of products.

7. The system of claim 6, wherein there are multiple categories with each category associated with a different level of priority.

8. The system of claim 7, wherein the categorization engine categorizes the plurality of products by determining a total value of the metric for all of the plurality of products, assigns the plurality of products that equal the percentage of the total value to a first category, and assigns the plurality of products that equal a percentage associated with a second category to the second category.

9. The system of claim 6, wherein the categorization engine further categorizes each of the ranked plurality of products different for a plurality of time periods.

10. The system of claim 6, wherein the product lifecycle indicator designates that the at least one product is an end of life product.

11. A non-transitory, computer-readable storage device containing code that, when executed by at least one processor, causes the at least one processor to:
rank order a plurality of products based on weights assigned to each metric of a plurality of metrics; and
categorize each of the ranked plurality of products based on at least one metric of the plurality of metrics and a percentage of the at least one metric associated with a plurality of categories, wherein the category determines an inventory level priority to assign to each of the plurality of products and wherein a number of products of the plurality of products are given a first category based on the metric and the percentage; and
replace the category of at least one product of the ranked plurality of products based on an override indicator associated with the at least one product.

12. The non-transitory, computer-readable storage device of claim 10, further causes the at least one processor to categorize each product of the plurality of products differently for each fiscal quarter of a plurality of fiscal quarters.

13. The non-transitory, computer-readable storage device of claim 10, wherein the plurality of metrics comprises volume, profit, and revenue.

14. The non-transitory, computer-readable storage device of claim 13, wherein the code, when executed by the at least one processor ranks the plurality of products first based on a weight assigned to the profit metric, then rank the products based on a weight assigned to the revenue metric, and then rank the products based on a weight assigned to the volume metric, wherein the revenue metric's weight is greater than the weights assigned to the profit and volume metrics.

15. The non-transitory, computer-readable storage device of claim 10, wherein the override indicator designates that the at least one product is a new product.

16. The non-transitory, computer-readable storage device of claim 10, wherein the override indicator designates that the at least one product is associated with a specific marketing strategy.

17. The non-transitory, computer-readable storage device of claim 10, wherein the code when executed by the at least one processor causes the at least one processor to determine product inventory targets.

18. The method of claim 1, wherein the indicator comprises a product lifecycle indicator that indicates that a product is at end of life.

19. The method of claim 1, wherein the ranking, the categorizing, the replacing in combination specify product inventory targets.

20. The system of claim 6, wherein the system is for determining product inventory targets, and wherein the categorization engine to receive the plurality of metrics.
